(19) United States
(12) Patent Application Publication
(10) Pub. No.: US 2011/0077851 A1
(43) Pub. Date: Mar. 31, 2011

(54) NAVIGATION DEVICE, METHOD AND PROGRAM

(75) Inventors: Tsuyoshi OGAWA, Aichi-ken (JP); Kiyonobu YAMAZAKI, Aichi-ken (JP)

(73) Assignee: AISIN AW CO., LTD., Aichi-ken (JP)

(21) Appl. No.: 12/851,609

(22) Filed: Aug. 6, 2010

(30) Foreign Application Priority Data
Sep. 30, 2009 (JP) 2009-226198
Mar. 31, 2010 (JP) 2010-084515

(51) Int. Cl. G01C 21/00

(52) U.S. Cl. 701/200

(57) ABSTRACT

In a navigation device or method, it is determined that an icon is selected by a touch at two points on a screen. It is further determined that the two touched points are moved in opposite directions with reference to the icon at a certain position where the selected icon is moved to. Subsequently, when it is detected that the touch at the two touched points is cancelled (removed), a function associated with the icon is executed with respect to the certain position.

### CROSS-REFERENCE TO RELATED APPLICATION(S)

The disclosure of Japanese Patent Application No. 2009-226198 filed on Sep. 30, 2009 and No. 2010-084515 filed on Mar. 31, 2010, including the claims, specification, drawings and abstract thereof, is incorporated herein by reference in its entirety.

### BACKGROUND

1. Technical Field

The present disclosure relates to a navigation device, a method and a program that display an icon, such as a mark, on a map displayed on a screen, and more particularly, to a navigation device, a method and a program capable of executing a specific function by operating the icon on the map.

2. Related Art

In navigation devices, a host's position and a movement speed are calculated in real time by using signals from a GPS (Global Positioning System) satellite. The navigation devices of this kind are common for mobile objects such as an automobile and portable devices.

Such navigation devices display a map on its screen based on computerized map data, and indicate the host's position on the map. Further, such navigation devices include a function that provides guidance for driving based on a route set by an operator of the navigation devices, e.g., by specifying a departure point, a destination, a midway point, and the like.

Japanese Patent Application Publication No. JP-A-2002-328028 (corresponding to U.S. Pat. No. 6,687,614) discloses such a navigation device which, when an input function button and an arbitrary coordinate on the map are designated, generates and displays a mark associated with the input function button at a position on the map corresponding to the designated coordinate. Specifically, input function buttons associated with specific processing are displayed together with the map on a display part, and when an input function button and an arbitrary coordinate on the map are designated via a touch panel, a mark is generated and displayed at the position on the map corresponding to the coordinate. The mark here represents for example a favorite point, a destination, and a midway point.

In addition, after the mark has been generated, when the coordinate corresponding to the mark displayed on the map is designated, information (an object) relating to the mark is displayed.

The information relating to the mark is guide information such as business hour, non-business day, an address, a telephone number, a picture (an image) introducing the place, and the like, if the place corresponding to the mark is a facility or a store. Such information is previously associated with the place and stored in a predetermined data storage part, a recording disk, or the like.

According to Japanese Patent Application Publication No. JP-A-2002-328028, the input function buttons for setting a departure point, a destination, a midway point, a deletion of a preexisting departure, destination or midway point from the map, and the like, to be selected by the operator of the navigation device are displayed on the screen. When the operator moves a finger or a pen touching the touch panel to an arbitrary coordinate on the map, a function that sets a departure point, a destination, a midway point, or deletes one of such points, and the like can be performed by the navigation device at the arbitrary coordinate.

### SUMMARY

In an aspect, a navigation device includes a display unit, an icon selection unit, an icon position setting unit and a control unit. The display unit displays a map and an icon. The icon selection unit determines that the icon is selected when the icon is located within a predetermined area from a midpoint of two points touched on the display unit. The icon position setting unit sets a position of the icon on the map, where the selected icon is moved to, as a target position if the two touched points selecting the icon are rotated about the icon. The control unit executes a function associated with the icon with respect to the target position.

In a navigation method in accordance with another aspect, a map and an icon are displayed on a display unit having a touch panel. A touch on the touch panel at two touched points is detected. A determination is made as to whether the icon is selected by the touch at the two touched points. A detection is made as to whether the two touched points are rotated about the icon at a position on the map where the selected icon is moved to. In response to a detection that the two touched points are rotated about the icon at the position and upon removal of the touch at the two touched points, a function associated with the icon is executed with respect to the position. In a navigation method in accordance with another aspect, a map and an icon are displayed on a display unit having a touch panel. A touch on the touch panel at two touched points is detected. A determination is made as to whether the icon is selected by the touch at the two touched points. Information of a plurality of functions associated with the icon is respectively displayed in a plurality of information items in the vicinity of the selected icon. In response to a detection that any of the two touched points is placed over one of the information items and upon subsequent removal of the touch at the two touched points, the function corresponding to the information item is executed with respect to a current position of the icon on the map. In a still further aspect, a computer-readable medium containing a program for executing the method(s) is also provided.

### BRIEF DESCRIPTION OF THE DRAWINGS

FIG. 1 is a block diagram showing an overall structure of a navigation device according to an embodiment of the present invention.

FIG. 2 is a schematic view of a screen of the navigation device according to the embodiment of the present invention.

FIGS. 3A, 3B, 3C, and 3D are schematic view for explaining destination setting of the navigation device according to the embodiment of the present invention.

FIG. 4 is a flowchart of a “destination setting routine” of the navigation device according to the embodiment of the present invention.

FIG. 5 is a chart showing further settings according to further embodiments.

FIGS. 6 and 7 are schematic views that show examples of destination setting of the navigation device according to further embodiments.

### DETAILED DESCRIPTION

One or more embodiments of the present invention will be described in further detail below with reference to the accompanying drawings. In the description, the same symbols and signs in the drawings refer to the same or corresponding elements or function parts; therefore, overlapped explanation will be omitted.

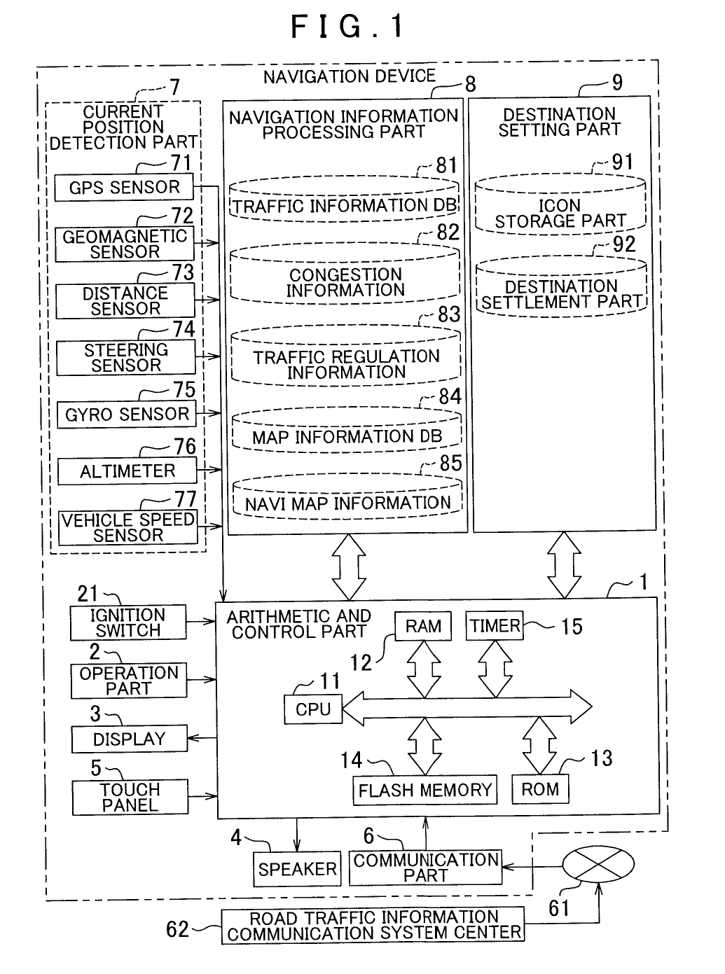

FIG. 1 is a block diagram showing an overall structure of a navigation device according to an embodiment of the present invention. The navigation device is for use in a vehicle, such as an automobile, or is a portable device arranged for use by a pedestrian or hiker or rider etc. Such a navigation device in some embodiments include any vehicle-built-in or after-market devices as well as mobile or portable devices, such as cellular telephones, personal digital assistants, laptop or tablet computers etc.

The navigation device includes a hardware computer platform, that can execute software applications and display guidance data. The navigation device is considered to include multiple units each for performing one or more specific functions. The functions are embodied in hardware either via hardwiring (e.g., as one or more ASIC(s)—application specific integrated circuit) or via software execution on such hardware. Software comprising instructions for execution resides in a computer-readable medium (i.e., readable and executable by a computer platform) as will be described herein below in detail.

In FIG. 1, the navigation device according to the present embodiment includes an arithmetic and control part 1, an operation part 2, a display 3, a speaker 4, a current position detection part 7, a communication part 6, a navigation information processing part 8, a destination setting part 9, and the like. The arithmetic and control part 1 is configured with a microprocessor that performs various kinds of arithmetic processing based on input information. The operation part 2 includes various keys including an ignition switch 21 that accepts operation from a operator to drive an engine, a microphone for an audio input, a touch switch, and the like. The display 3 includes a liquid crystal display, an electro-luminescent display (ELD), and the like that display to the operator operation information and information of a map and the like. The speaker 4 performs audio guidance regarding route guidance and guidance of traffic regulation information and congestion information. The current position detection part 7, which detects a current position of a vehicle, includes various sensors so as to be able to detect the current position of the vehicle, a direction, a distance to an object (for example, an intersection), and the like. The communication part 6 performs communication with an information center such as a VICS (a registered trademark: Vehicle Information and Communication System) center 62 via a network 61. The navigation information processing part 8, in which various kinds of data is stored, includes a hard disk with a large storage capacity that is capable of writing and reading. The destination setting part 9 searches for a route upon setting a destination by a navigation function. In addition, the display 3 may serve as a touch switch as the operation part 2.

The arithmetic and control part 1 configured with the microprocessor includes; a CPU 11 that performs computing for an overall control and control; internal storage devices such as a RAM 12, a ROM 13, and a flash memory 14; a timer 15; and the like. The RAM 12 is used as a working memory when the CPU 11 performs various computing processing and also stores route data when a route has been searched, a link ID having the traffic regulation information, and the like. The ROM 13 stores a control program and a route change guidance processing program that provides a user with guidance for changing to a congestion-avoided route. The flash memory 14 stores a program read from the ROM 13. A semiconductor memory, a magnetic core, and the like are utilized as the RAM 12, the ROM 13, the flash memory 14, and the like. A unit having a computing function such as a MPU can be utilized as the CPU 11 that performs computing and control.

The ROM 13 stores various programs, and the RAM 12 stores various data. The programs, the data, and the like are read from an external storage device, a memory card, and the like and written in the flash memory 14. Further, the programs, the data, and the like can be updated by changing the memory card and the like.

The current position detection part 7, which detects the current position of the vehicle, includes a GPS sensor 71, a geomagnetic sensor 72, a distance sensor 73, a steering sensor 74, a gyro sensor 75 as a direction detection part, an altimeter 76, and a vehicle speed sensor 77 that detects a travel speed and a travel distance of the vehicle, and the like.

The navigation device according to the present embodiment is capable of receiving, at intervals of a predetermined time, road traffic information such as the traffic regulation information, and information relating to congestion of a road and the like, which were created by collecting information of a road traffic control system of the police, the Japan Highway Public Corporation, or the like from the road traffic information communication system center 62 via the network 61. The road traffic information is for example detailed information relating to the road traffic information such as road congestion information regarding a congestion of a road and the road regulation information due to road construction, building work, or the like. The detailed information includes, for the road congestion information, an after-mentioned VICS link ID, an actual length of the congestion, an expected time when the congestion is solved, and the like, and for the traffic regulation information, the after-mentioned VICS link ID, duration of road construction, building work, and the like, types of traffic regulation such as a closed road, alternately-closed one-way traffic, lane regulation, a period of time of the traffic regulation, and the like.

In addition, as the network 61, a communication system such as a wireless LAN (Local Area Network), a WAN (Wide Area Network), an intranet, a cellular phone network, a telephone network, a public communication network, a private communication network, a communication network such as Internet, and the like can be utilized for example. In addition, a communication system using CS broadcasting, BS broadcasting, digital terrestrial broadcasting, FM multiplex broadcasting, and the like can be utilized. Further, a communication system such as an electronic toll collection system (ETC) used in an intelligent transportation system (ITS), a dedicated short range communication system (DSRC), and the like also can be utilized.

The GPS sensor 71 receives radio waves generated by an artificial satellite to detect the current position of the vehicle on the earth and the current time. The geomagnetic sensor 72 measures geomagnetism to detect a direction of the vehicle. The distance sensor 73 detects a distance between predetermined positions on a road, and the like. For example, the distance sensor 73 here measures a rotation speed of a wheel of the vehicle and detects the distance based on the measured rotation speed. However, the distance may be detected by integrating output of the vehicle speed sensor 77.

The steering sensor 74 detects a steering angle of the vehicle. Here, as the steering sensor 74, an optical rotation sensor mounted on a rotating part of a steering wheel, a rotational resistance sensor, an angle sensor mounted on a wheel, or the like is used for example.

The gyro sensor 75 detects a turn angle of the vehicle. Here, as the gyro sensor 75, a gas rate gyro, a vibration gyro, or the like is used for example. In addition, by integrating the turn angle detected by the gyro sensor 75, the direction of the vehicle can be detected.

In the present embodiment, the navigation information processing part 8 and the destination setting part 9 are described for a case of using a hard disk. In the present embodiment, a hard disk is used as the navigation information processing part 8 and the destination setting part 9. However, in addition to the hard disk, a magnetic disk such as a flexible disc or the like can be used as a part of the external storage device. Further, the memory card, a magnetic tape, a magnetic drum, a CD, a MD, a DVD, an optical disk, an IC card, and the like can be used as a part of the external storage device. The RAM 12, ROM 13, flash memory 14, navigation information processing part 8 and/or the destination setting part 9 is/are also referred to herein as a computer-readable recording medium or media.

The arithmetic and control part 1 is electrically connected to the respective peripheral devices of the operation part 2, the display 3, the speaker 4, a touch panel 5, and the communication part 6. The operation part 2 is operated when changing the current position at the time of starting travel and inputting a departure point as a guidance start point and a destination as a guidance end point, or when performing search for information relating to a facility, and includes a plurality of operation switches such as various keys. The arithmetic and control part 1 performs control to execute various operations according to a switch signal outputted by the operation on each switch of the operation part 2. The ignition switch 21 performs start and stop of an engine.

As the operation part 2, a keyboard, a mouse, a bar-code reader, a remote control device for remote operation, a joystick, a light pen, a stylus pen, and the like can be also utilized. In addition, the operation part 2 can be configured with the touch panel 5 installed in front of the display 3.

On a screen 32 of the display 3, operation guidance, a operation menu, key guidance, a map, various types of icons, a searched route from the current position to the destination, guidance information along the searched route, a route change guidance information described later, traffic information, news, weather forecast, time, E-mail, TV programs, and the like are displayed.

As the display 3, a CRT display, a plasma display, ELD, OLED (organic light emitting diode) or the like can be utilized. Also, a hologram device that project hologram on a front glass of a vehicle can be utilized.

The speaker 4 outputs audio guidance for traveling along the searched route and for a change of the searched route based on an instruction from the arithmetic and control part 1. The audio guidance to be provided here includes for example “200 m ahead, to the right direction at XX intersection”, “The route is changed to a route using toll roads”, and the like. Especially, in the present embodiment, messages for operation order and the like are outputted.

As the audio outputted by the speaker 4, various types of sound effect and various guidance information previously-recorded in an IC memory or the like can be outputted in addition to a synthesized sound.

Further, the communication part 6 is a beacon receiver that receives, as a radio wave beacon, an optical beacon, and the like via a radio wave beacon device, an optical beacon device, and the like, the road traffic information including various information such as the congestion information, the traffic regulation information, parking lot information, traffic accident information, congestion status of service areas, which were sent from an information center such as the road traffic information communication system center 62 or the like. The radio wave beacon device and the optical beacon device are installed along a road. In addition, the communication part 6 is a network device that realizes communication on the communication system such as the LAN (Local Area Network), the WAN (Wide Area Network), the intranet, the cellular phone network, the telephone network, the public communication network, the private communication network, the communication network such as the Internet, and the like as the network 61. Further, the communication part 6 includes a FM receiver that receives, as the FM multiplex broadcasting via a FM broadcasting station, FM multiplex information including information of news, weather forecast, and the like, besides the information from the road traffic information communication system center 62. The beacon receiver and the FM receiver are unitized and installed as a VICS receiver; however, these can be separately installed.

A traffic information DB 81 of the navigation information processing part 8 stores congestion information 82 created from the road traffic information relating to the current congestion of the road including an actual length of the congestion, the expected time when the congestion is solved, and the like, which is received from the road traffic information communication system center 62. In addition, the traffic information DB 81 stores traffic regulation information 83 created from the road traffic information relating to the road regulation information due to the road construction, the building work, or the like including traffic regulation, which is received from the road traffic information communication system center 62.

The road traffic information received from the road traffic information communication system center 62 includes the VICS link ID together with type information, information of a position, a distance of a congested section, a congestion level, and the like. The VICS link ID is an identification number assigned to a VICS link as a travel guidance link, which is standardized by dividing a road at every predetermined intersection. In addition, the road traffic information includes information of coordinates of a start point and an end point of each VICS link and the distance from the start point and the end point, and the like.

The road stored in a map information DB 84 and the VICS link are not the same. That is, the road (the link) is generally divided shorter than the VICS link. The traffic information DB 81 includes a conversion table between a link ID assigned as an identification number to each road and the VICS link ID, thereby a corresponding link ID can be determined based on the VICS link ID. Therefore, when receiving the VICS link ID from the road traffic information communication system center 62, the navigation device according to the present embodiment can determine, based on the VICS link ID, the section of the road, for which the road traffic information such as the congestion information and the like should be displayed. The VICS link ID of the road traffic information relating to the current congestion of the road and the like received from the road traffic information communication system center 62 is converted into the link ID and stored as the congestion information 82. Also, the VICS link ID of the road traffic information relating to the traffic regulation information 83 and the like received from the road traffic information communication system center 62 is converted into the link ID and stored as the traffic regulation information 83.

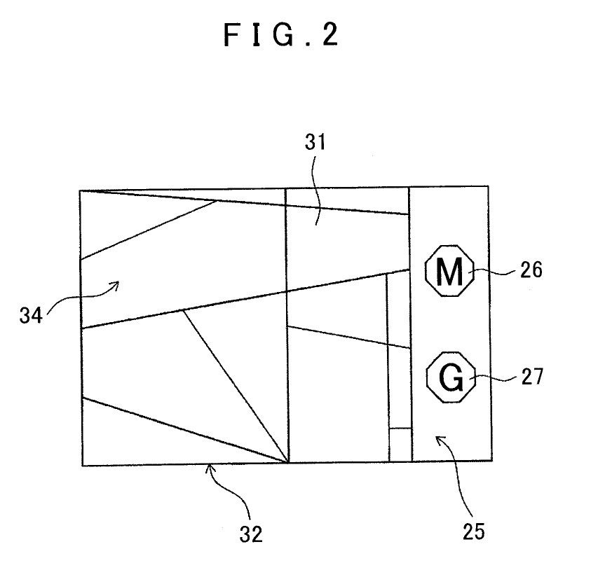

In addition, the map information DB 84 stores navi map information 85 that is used in travel guidance and route search in the navigation device according to the present embodiment. The navi map information 85 includes various information necessary for route guidance and map display, for example, newly-created road information for determining newly-created roads, map display data for displaying a map 31 (see FIG. 2), intersection data relating to each intersection, node data relating to a node point, link data relating to a road as a kind of facility, route search data for searching for a route, shop data relating to a POI (Point of Interest) such as a shop as a kind of the facility, and the like, search data for searching for a point, and the like. Contents of the map information DB 84 are updated by downloading update information delivered via the communication part 6 from a map information delivery center.

The destination setting part 9 includes an icon storage part 91 and a destination settlement part 92. The icon storage part 91 is a memory area to store icons used by the operator. In the present embodiment, among various types of icons, a memory point icon 26 and a destination icon 27 (see FIG. 2) are stored. The memory point icons 26 and the destination icon 27 are displayed in an icon area 25 on the screen 32 of the display 3 (see FIG. 2).

When the icon selected by the operator is moved to a certain position on the map 31, the destination settlement part 92 sets the position where the icon is moved to as a memory point if the icon 26 is selected and moved, and the destination settlement part 92 sets the position where the icon is moved to as the destination if the icon 27 is selected and moved. In some configurations, the destination settlement part 92 is configured as a part of the arithmetic and control part 1, especially by the CPU 11.

Next, the control of the navigation device according to the present embodiment, which is processed by the arithmetic and control part 1, will be described.

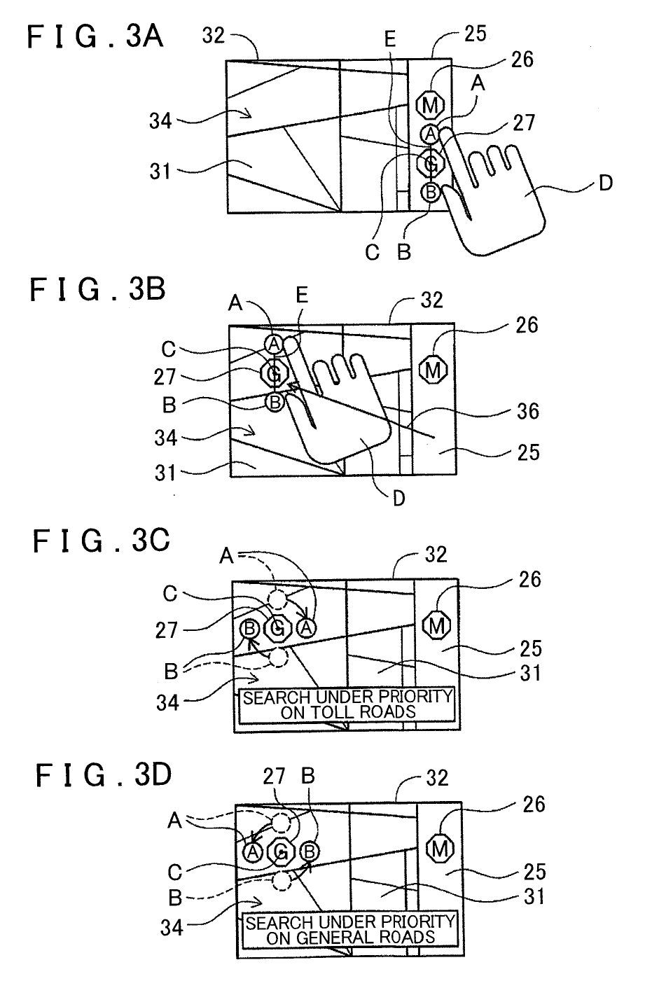

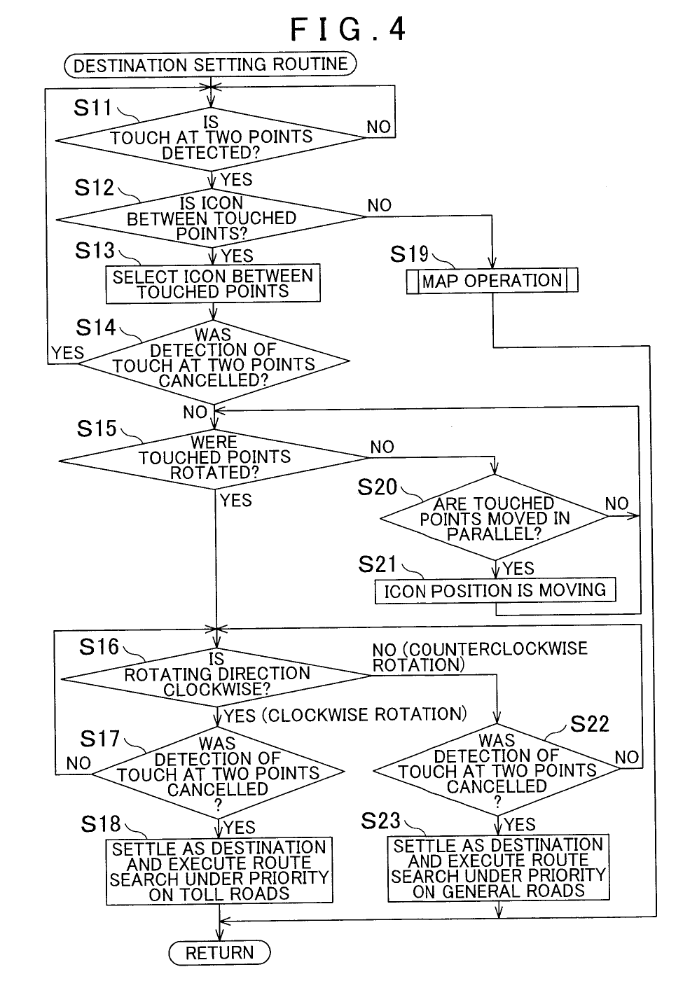

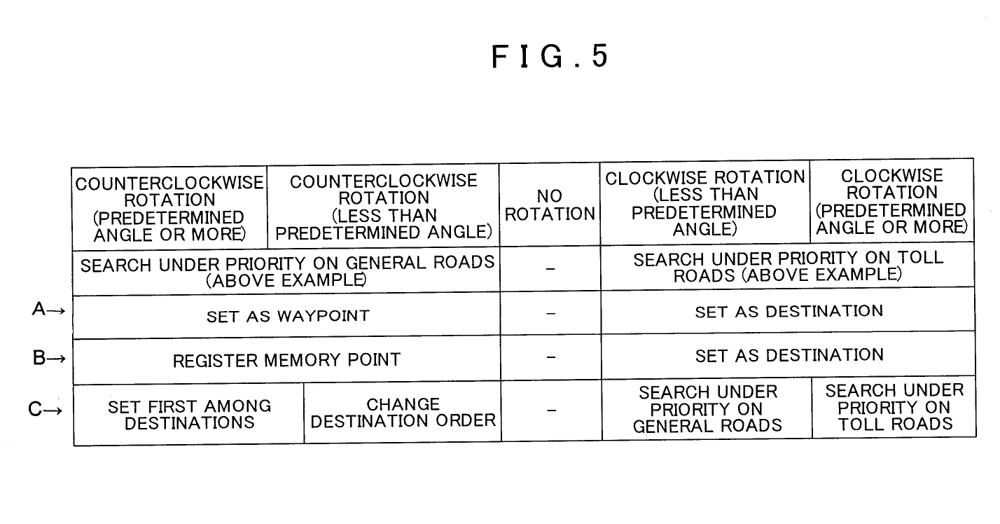

FIG. 2 is a schematic view of a screen of the navigation device according to the embodiment of the present invention. FIGS. 3A, 3B, 3C, and 3D are schematic views for explaining destination setting of the navigation device according to the present embodiment. FIG. 4 is a flowchart of a “destination setting routine” of the navigation device according to the present embodiment. FIG. 5 is a chart showing further settings according to further embodiments.

As shown in FIG. 2, the map 31 and a plurality of icons 26 and 27 are displayed on the screen 32 of the display 3 by execution of a main program (not shown). The screen 32 includes a map display part 34 for displaying the map 31 at the center of the screen and the icon area 25, where various types of icons are allocated, at the right side of the map display part 34. In the icon area 25, from the top, the memory point icon 26 and the destination icon 27 are allocated. When a “destination setting routine” (as will be described herein below with respect to FIG. 4) is executed, the destination icon 27 is set at a certain position on the map 31 and a route search is executed.

Here, functions are assigned to the respective icons displayed in the icon area 25. When the user selects and moves these icons on the screen, the assigned functions are executed with respect to the positions after the movement. For example, the memory point icon 26 includes a function to register the position after the movement as the memory point, and the position registered as the memory point will be easily recalled later on the map. The destination icon 27 includes a function to set the position after the movement as the destination, and a route to the destination is searched by the arithmetic and control part 1.

Next, the method for setting the destination will be described with reference to FIGS. 3A to 3D.

First, in FIG. 3A, the operator that operates the navigation device touches the screen at two touched points, e.g., with two fingers of his/her hand D, in a manner such that the destination icon 27 in the icon area 5 is pinched. Specifically, the two fingers of the operator touch a point A and a point B on the screen. (The point A, the point B, their midpoint C, and a straight line E in FIG. 3A are not actually displayed on the screen. They are indicated in FIG. 3 for explanatory purposes only.) The two touched points (XA1, YA1) and (XB1, YB1) are detected as a detected touched point position A and a detected touched point position B, respectively. If the touched points (XA1, YA1) and (XB1, YB1) are detected in a manner such that the destination icon 27 is pinched, it is determined that the destination icon 27 is selected. Specifically, if it is determined that the detected touched point position A is within a predetermined area around the destination icon 27 and the detected touched point position B is located in an opposite side of the detected touched point position A in relation to the destination icon 27 within the predetermined area, it is determined that the destination icon 27 is selected. That is, it is determined that the operator pinches the destination icon 27. In a specific configuration of the present embodiment, it is determined that the operator pinches the destination icon 27 if a midpoint C of the touched points (XA1, YA1) and (XB1, YB1) is at an approximate center of the destination icon 27. However, in another configuration, it is determined that the operator pinches the destination icon 27 if the midpoint C of the touched points (XA1, YA1) and (XB1, YB1) is located at any part of the destination icon 27.

In FIG. 3B, after the destination icon 27 is selected and it is determined that the operator pinches the destination icon 27, if the operator moves the respective points (XA1, YA1) and (XB1, YB1) in the direction of an arrow 36 while keeping a positional relationship between the two touched points (XA1, YA1) and (XB1, YB1), it is determined that the destination icon 27 is being moved. The operator moves the destination icon 27 by moving the two fingers to a certain position on the map 31 in the map display part 34.

Next, in FIG. 3C, if the operator, having moved the destination icon 27 to the certain position on the map 31 in the map display part 34, rotates the two fingers in a clockwise direction at the moved position, and then moves the two fingers away from the screen 3, the position of the destination icon 27 is set as the destination. That is, if the two touched points (XA1, YA1) and (XB1, YB1) on the screen 32 are rotated approximately about the midpoint C in a predetermined direction, for example, in the clockwise direction, and the touch at the two touched points is subsequently cancelled (removed), the position of the destination icon 27 when the two fingers move away from the screen is set as the target position of the destination icon 27 that the operator wants to set on the map 31 of the map display part 34. After that, a route search is executed using such target position as the destination. In the present embodiment, in response to the rotation of the two touched points in the clockwise direction, the route search with priority on toll roads is executed, and a message “search with priority on toll roads is executed” is displayed at the lower part of the screen 32. If the touched points of the two fingers are located in approximate opposite sides about the destination icon 27 and movement directions of the respective touched points are in opposite directions about the position of the destination icon 27, it is determined that the two fingers selecting (pinching) the destination icon 27 are being rotated.

Thus, the following potential issue can be avoided. The issue is that while the operator is moving the destination icon 27 to the certain position on the map 31, if the operator unintentionally moves one or both fingers away from the screen 32, the position of the destination icon 27 at such moment may be incorrectly set as the destination and the route search may be undesirably executed with respect to the incorrect destination. However, in the present embodiment, if the operator unintentionally or inadvertently moves one or both fingers away from the screen 32, the position of the destination icon 27 at such moment will not be set as the destination and no route search will be executed.

In FIG. 3D, if the operator rotates the two fingers in a counterclockwise direction (rather than in the clockwise direction as described with respect to FIG. 3C) and then moves the two fingers away from the screen 32, the position of the destination icon 27 is set as the destination. That is, if the two touched points (XA1, YA1) and (XB1, YB1) touched on the screen 32 are rotated approximately about the midpoint C in another predetermined direction, for example, in the counterclockwise direction, and the touch at the two touched points is subsequently cancelled, the position of the destination icon 27 when the two fingers move away from the screen 32 is set as the target position of the destination icon 27 that the operator wants to set. After that, a route search using such target position as the destination is executed, as when the two touched points are rotated in the clockwise direction. However, the difference is that the route search is executed with priority on general (e.g., toll-free) roads, rather than on toll roads as when the two touched points are rotated in the clockwise direction. A message, e.g., “search with priority on general roads is executed” is displayed at the lower part of the screen 32.

The above described potential issue of incorrect setting of the destination is prevented by detecting the rotation about the midpoint C of the two touched points (XA1, YA1) and (XB1, YB1) before the touch at the two touched points (XA1, YA1) and (XB1, YB1) is cancelled. In addition, by changing the condition of the route search, for example, with priority on toll roads or general roads, according to the rotating direction, additional function(s) can be added without increasing the operation of the operator. As a result, the number of operations by the operator can be reduced.

Next, a control method for setting the destination of the navigation device according to the present embodiment, which is processed by the arithmetic and control part 1, will be described below.

First, with reference to FIG. 4, a flowchart of the “destination setting routine” of the navigation device according to the present embodiment will be described. This routine is called during execution of the main program of the navigation device.

First, at Step S11, it is determined whether or not the touch at two touched points is detected, that is, whether or not it has been detected that the operator touches the screen at two touched points. If YES, the procedure goes to Step S12. If NO, Step S11 is repeated until YES is determined at Step S11.

At Step S11, if YES is determined, that is, if it is determined that it has been detected that the operator touches the screen 32 at two touched points, the procedure goes to Step S12. At Step S12, it is determined whether or not the midpoint C of the two touched points on the screen 32 is on the destination icon 27. If YES, the procedure goes to Step S13. If NO, the procedure goes to Step S19.

At Step S12, if YES is determined, that is, if it is determined that the midpoint C of the two touched points is on the destination icon 27, the procedure goes to Step S13. At Step S13, it is determined that the destination icon 27 between the touched points is selected, that is, it is determined that the operator pinches the destination icon 27, and the procedure goes to Step S14.

On the other hand, at Step S12, if NO is determined, that is, if it is determined that the midpoint C of the two touched points is not on the destination icon 27, the procedure goes to Step S19 where it is determined that the operator merely operates the map, and the routine is returned.

At Step S13, the destination icon 27 is moved to an arbitrary position on the map 31 by the operator. However, at Step S15, the position of the destination icon 27 is not set as the destination until it is determined that the touched points are rotated. Therefore, at Step S14, it is determined whether or not the detection of the touch at the two touched points is cancelled, that is, it is determined whether or not the touch at the two touched points is unintentionally cancelled while moving the destination icon 27 to the arbitrary position on the map 31. If NO, the procedure goes to Step S15. If YES, the procedure returns to Step S11. Step S11 is repeated until YES is determined at Step S11.

At Step S14, if YES is determined, that is, if the detection of the touch at the two touched points is cancelled, the procedure returns to Step S11. That is, whether or not the touch at the two touched points is detected can be determined, and from the position where the touch at the two touched points is cancelled, the destination icon 27 is reselected. At Step S14, even if the touch at the two touched points is cancelled, the position where the touch is cancelled is not set as the destination; therefore, a route search is not executed.

On the other hand, at Step S14, if NO is determined, that is, if the detection of the touch at the two points is not cancelled, the procedure goes to Step S15. At Step S15, it is determined whether or not the touched points are rotated. If YES, the procedure goes to Step 516. If NO, the procedure goes to Step S20.

The destination icon 27 is moved to the certain position of the map 31 on the screen 32 by the operator. Then, at Step S15, it is determined whether or not the touched points are rotated, that is, whether or not the two touched points are rotated about the midpoint C of the two touched points. If YES, the procedure goes to Step S16. If NO, the procedure goes to Step S20.

At Step S15, if YES is determined, that is, if it is determined that the two touched points are rotated about the midpoint C of the two touched points, the procedure goes to Step S16. At Step S16, it is determined whether the rotating direction is clockwise or counterclockwise. If YES (clockwise), the procedure goes to Step S17. If NO (counterclockwise), the procedure goes to Step S22.

On the other hand, at Step S15, if NO is determined, that is, if it is not detected that the two touched points are rotated about the midpoint C of the two touched points, the procedure goes to Step S20. At Step S20, it is determined whether or not the touched points are moved in parallel, that is, it is determined whether or not the two touched points are moved in the same direction while keeping a space between the two touched points. If YES, the procedure goes to Step S21. If NO, Step S15 is repeated until YES is determined at Step S15.

If YES is determined at Step S20, that is, if it is determined that the two touched points have been moved in the same direction while keeping the space therebetween, the procedure goes to Step S21. At Step S21, it is determined that the destination icon 27 is being moved on the screen 32, and Step S15 is repeated until YES is determined at Step S15.

At Step S16, if YES is determined, that is, if it is determined that the rotation is clockwise, the procedure goes to Step S17. At Step S17, it is determined whether or not the detection of the touch at the two touched points is cancelled. If YES, the procedure goes to Step S18. If NO, the procedure returns to Step S16.

At Step S17, if YES is determined, that is, if it is determined that the detection of the touch at the two touched points is cancelled, the procedure goes to Step S18. At Step S18, the position of the destination icon 27 on the screen 32 where the touch is cancelled is set as the destination, and the route search to the destination is executed with priority on toll roads, and the routine is returned.

On the other hand, at Step S16, if NO is determined, that is, if it is determined that the rotation is counterclockwise, the procedure goes to Step S22 where it is determined whether or not the detection of the touch at the two touched points is cancelled. If YES, the procedure goes to Step S23. If NO, the procedure returns to Step S16.

At Step S22, if YES is determined, that is, if it has been determined that the detection of the touch at the two touched points is cancelled, the procedure goes to Step S23. At Step S23, the position of the destination icon 27 on the screen 32 where the touch is cancelled is set as the destination, the route search to the destination is executed with priority on general roads, and the routine is returned.

In some configurations, Steps S11, S12, S13 and S19 are performed by an icon selection unit, Steps 514-S17, S20-S22 and the destination setting parts of Steps S18 and S23 are performed by an icon position setting unit, and the execution parts of Steps S18 and S23 are performed by a control unit. Other arrangements of the Steps among the icon selection unit, icon position setting unit, and control unit are within the scope of this disclosure.

In some configurations, one or more of the icon selection unit, icon position setting unit, and control unit is/are hardware, such as one or more ASIC(s) specifically configured to perform the respective function(s) described herein. In some configurations, one or more of the icon selection unit, icon position setting unit, and control unit is/are configured by the CPU 11 being appropriately programmed.

FIG. 5 a chart showing further settings of further embodiments. Row (A) of FIG. 5 shows that: if the two points touched by the operator are rotated in the counterclockwise direction about the midpoint C of the two touched points, the position of the icon is set as a midway point; and if the two touched points are rotated in the clockwise direction, the position of the icon is set as the destination. The midway point herein represents a point to pass or stop by on the way to the destination when a route to the destination is searched. Consequently, if a midway point has been set, a new route to the destination via the midway point is searched.

Next, row (B) of FIG. 5 shows that: if the two points touched by the operator are rotated in the counterclockwise direction about the midpoint C of the two touched points, the position where the icon is located is set as a memory point; and if the two touched points are rotated in the clockwise direction, the position where the icon is located is set as the destination.

In addition, row (C) of FIG. 5 shows that further functions are added by detecting a rotation angle, e.g., by the icon position setting unit, in addition to detecting the rotating direction. For example, if the two points touched by the operator are rotated in the counterclockwise direction about the midpoint C a predetermined angle or more, the position where the icon is located is set as the first destination for which a route search is to be executed. Any pre-existing destination(s) that might have been set by the operator before will be the second destination, third destination and so on. If the two points touched by the operator are rotated in the counterclockwise direction about the midpoint C less than the predetermined angle, the operator is given an opportunity to change the passing order among multiple destinations as will be discussed herein with respect to FIG. 7.

If the two points touched by the operator are rotated in the clockwise direction about the midpoint C a predetermined angle or more, the position where the icon is located is set as the destination for which a route search with priority on general roads is executed.

If the two points touched by the operator are rotated in the clockwise direction about the midpoint C less than the predetermined angle, the position where the icon is located is set as the destination for which a route search with priority on toll roads is executed.

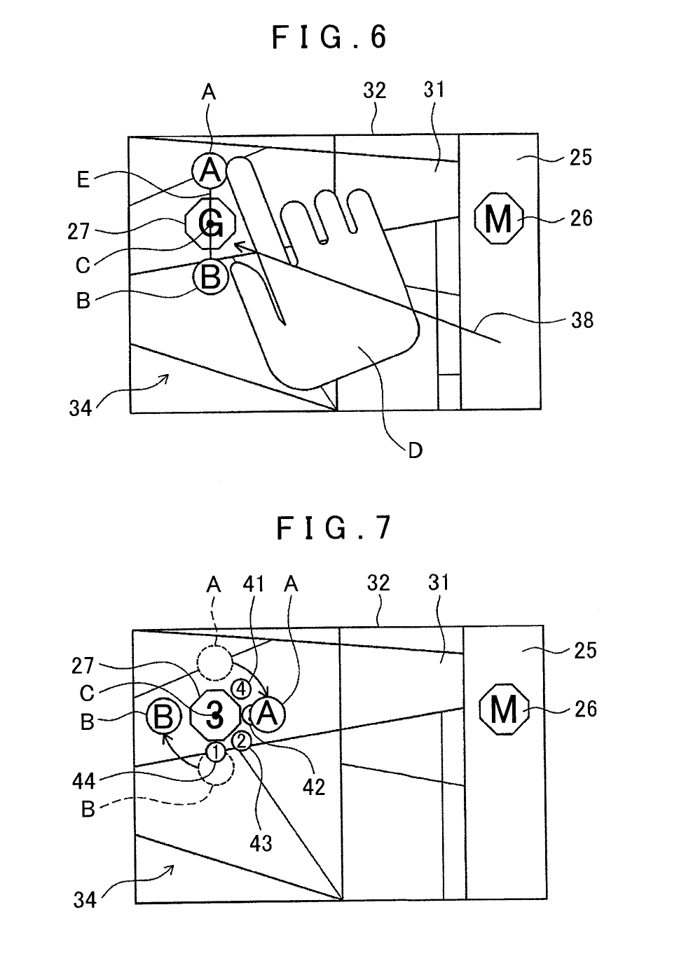

Further embodiments will be described with reference to FIGS. 6 and 7. Herein, operations from a state where there is at least one pre-existing destination, e.g., three destinations are already set, and a route passing through the three destinations is searched on the map 31 will be described.

As shown in FIG. 6, the operator that operates the navigation device touches the screen at two touched points, e.g., with two fingers of his/her hand D, such that the destination icon 27 in the icon area 25 is pinched. Specifically, the two fingers of the operator touch the point A and the point B on the screen. (The point A, the point B, their midpoint C, and the straight line E in FIGS. 6 and 7 are not actually displayed on the screen. They are indicated in FIGS. 6-7 for explanatory purposes only.)

After the destination icon 27 is selected and it has been determined that the operator pinches the destination icon 27, if the operator moved the two touched points (XA2, YA2) and (XB2, YB2) in parallel in the direction of an arrow 38 while keeping a space between the respective two touched points (XA2, YA2) and (XB2, YB2), it is determined that the destination icon 27 is being moved. The operator moves the destination icon 27 by moving the two fingers to a certain position on the map 31 in the map display part 34.

As shown in FIG. 7, while the destination icon 27 is being pinched, four information items, e.g., circles, 41, 42, 43, and 44 are displayed, e.g., by the icon selection unit, in the vicinity of the destination icon 27, and numbers “4”, “3”, “2”, “1” are displayed in sequential order in the respective circles 41, 42, 43, and 44. In various configurations, information items 41, 42, 43, and 44 are squares, triangles, rhombuses, or the like.

In some configurations, information items 41, 42, 43, and 44 are displayed when the two touched points are rotated, e.g., in the counterclockwise direction about the midpoint C less than the predetermined angle, as discussed above with respect to FIG. 5, row C.

In further configurations, information items 41, 42, 43, and 44 are displayed when the destination icon is located at the same position on the map for a predetermined period of time.

The numbers “4”, “3”, “2”, and “1” displayed in the respective circles 41, 42, 43, and 44 represent a passing order that corresponds to the four destinations 27 including the already set three destinations (not shown) and a fourth destination to be set by the pinched destination icon 27. Similarly, for example, if four destinations are already set and a fifth destination is to be set by the pinched destination icon 27, five circles are displayed in the vicinity of the destination icon 27 and numbers “5”, “4”, “3”, “2”, “1” are displayed in sequential order in the circles.

If one of the touched point, i.e., a finger of the operator, is placed over any of the circles 41, 42, 43, and 44, the number displayed in the circle where the finger is placed is displayed, e.g., by the icon selection unit, in place of a letter “G” on the destination icon 27. For example, as shown in FIG. 7, if the finger of the operator is placed over the circle 42 where the number “3” is displayed, the number “3” is displayed in place of the letter “G” on the destination icon 27. Subsequently, if the operator moves the two fingers away from the screen 32, the position of the destination icon 27 is set, e.g., by the icon position setting unit, as the third destination and the previous third destination is set as the fourth destination.

In addition, for example, if one of the touched point, i.e., the finger of the operator, is placed over the displayed circle 41 where the number “4” is displayed, the number “4” is displayed in place of the letter “G” on the destination icon 27. Subsequently, if the operator moves the two fingers away from the screen 32, the position of the destination icon 27 is set as the fourth destination.

Thus, the operator moves the destination icon 27 to a certain position and sets the destination at the certain position by rotating the two fingers in the predetermined direction, for example, in the clockwise direction. At this time, if the operator moves one of the fingers to be over the number indicating the passing order that the operator desires to set, among the respective numbers displayed in the vicinity of the destination icon 27, and moves the two fingers away from the screen 32, the operator can change the existing passing order of the respective destinations including the position of the just moved destination icon 27 and perform a route search.

In addition, if the finger of the operator is placed over any of the respective circles 41, 42, 43, and 44 displayed in the vicinity of the destination icon 27, the number displayed in the circle under the finger is displayed in place of the letter “G” on the destination icon 27. This enables the operator to easily confirm the number displayed in the circle under the finger and correctly set the passing order. As a result, the operability is improved.

In FIG. 7, the numbers representing the passing order are displayed in the vicinity of the destination icon 27. However, the present invention is not limited to this embodiment. For example, in place of the respective circles 41, 42, 43, and 44, squares, in which a word “Toll” representing a search condition with priority on toll roads, and a word “General” representing a search condition with priority on general roads, are displayed. Subsequently, if the operator moves the finger to be over any of the squares and then moves the two fingers away from the screen 32, a route search is executed under the search condition displayed in the square. In addition, if the finger of the operator is placed over any of the respective squares, the word displayed in the square is displayed in place of the letter “G” on the destination icon 27.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A navigation device comprising:
a display unit for displaying a map and an icon;
an icon selection unit for determining whether the icon is selected;
an icon position setting unit for setting a position of the icon on the map, where the selected icon is moved to, as a target position; and
a control unit for executing a function associated with the icon with respect to the target position,
wherein
the icon selection unit is configured to determine that the icon is selected when the icon is located within a predetermined area from a midpoint of two points touched on the display unit, and
the icon position setting unit is configured to set the position of the icon as the target position if the two touched points selecting the icon are rotated about the icon.

2. The navigation device according to claim 1, wherein
the icon is associated with two functions respectively corresponding to first and second rotating directions of the two touched points selecting the icon,
the icon position setting unit is configured to detect whether the two touched points selecting the icon are rotated in the first or second rotating direction, and
the control unit is configured to execute the respective function corresponding to the first or second rotating direction as detected by the icon position setting unit.

3. The navigation device according to claim 2, wherein
each of the functions associated with the icon includes (i) designating a route search condition corresponding to one of the first and second rotating directions, and (ii) performing a route search using the target position as a destination, and
the control unit is configured to set the route search condition according to the first or second rotating direction as detected by the icon position setting unit, and to execute the route search with the target position being set as the destination.

4. The navigation device according to claim 1, wherein
the icon position setting unit is configured to determine that the two touched points selecting the icon are rotated if the two touched points selecting the icon are located on opposite sides of the icon and are moved in opposite directions about the icon.

5. The navigation device according to claim 4, wherein
the icon is associated with two functions respectively corresponding to first and second rotating directions of the two touched points selecting the icon,
the icon position setting unit is configured to detect whether the two touched points selecting the icon are rotated in the first or second rotating direction, and
the control unit is configured to execute the respective function corresponding to the first or second rotating direction as detected by the icon position setting unit.

6. The navigation device according to claim 5, wherein
each of the functions associated with the icon includes (i) designating a route search condition corresponding to one of the first and second rotating directions, and (ii) performing a route search using the target position as a destination, and
the control unit is configured to set the route search condition according to the first or second rotating direction as detected by the icon position setting unit, and to execute the route search with the target position being set as the destination.

7. The navigation device according to claim 1, wherein
the icon is associated with a plurality of functions respectively corresponding to a plurality of rotating angles of the two touched points selecting the icon,
the icon position setting unit is configured to detect a rotating angle of the two touched points selecting the icon, and
the control unit is configured to execute the function corresponding to the rotating angle as detected by the icon position setting unit.

8. The navigation device according to claim 7, wherein
the icon selection unit is configured to display information of the plurality of functions associated with the icon respectively in a plurality of information items in the vicinity of the selected icon, and
the control unit is configured to execute the function corresponding to the information item over which any of the two touched points is placed, when a touch of the two touched points selecting the icon is cancelled.

9. The navigation device according to claim 8, wherein
the icon selection unit is configured to display over the icon the information of the function corresponding to the information item over which any of the two touched points selecting the icon is placed.

10. The navigation device according to claim 2, wherein
the icon is associated with a plurality of functions respectively corresponding to a plurality of rotating angles of the two touched points selecting the icon,
the icon position setting unit is configured to detect a rotating angle of the two touched points selecting the icon, and
the control unit is configured to execute the function corresponding to the rotating angle as detected by the icon position setting unit.

11. The navigation device according to claim 10, wherein
the icon selection unit is configured to display information of the plurality of functions associated with the icon respectively in a plurality of information items in the vicinity of the selected icon, and
the control unit is configured to execute the function corresponding to the information item over which any of the two touched points is placed, when a touch of the two touched points selecting the icon is cancelled.

12. The navigation device according to claim 11, wherein
the icon selection unit is configured to display over the icon the information of the function corresponding to the information item over which any of the two touched points selecting the icon is placed.

13. A navigation method, comprising:
displaying, on a display unit having a touch panel, a map and an icon;
detecting a touch on the touch panel at two touched points;
determining whether the icon is selected by the touch at the two touched points;
detecting whether the two touched points are rotated about the icon at a position on the map where the selected icon is moved to;
in response to a detection that the two touched points are rotated about the icon at said position and upon removal of the touch at the two touched points, executing a function associated with the icon with respect to said position.

14. The navigation method according to claim 13, further comprising:
inhibiting execution of said function in an absence of the detection that the two touched points are rotated about the icon.

15. The navigation method according to claim 13, further comprising:
upon removal of the touch at one or both of the two touched points and in an absence of the detection that the two touched points are rotated about the icon, reselecting the icon without executing the function.

16. The navigation method according to claim 13, wherein
the icon is associated with a plurality of functions corresponding to at least one of (i) different rotating directions or (ii) different rotating angles of the two touched points about the icon,
said method further comprises detecting at least one of (i) a rotating direction or (ii) a rotating angle of the two touched points about the icon, and
said executing includes executing the function corresponding to at least one of (i) the detected rotating direction or (ii) the detected rotating angle of the two touched points about the icon.

17. The navigation method according to claim 13, wherein
the icon is associated with a plurality of functions,
said method further comprises displaying information of the plurality of functions respectively in a plurality of information items in the vicinity of the selected icon, and
said executing includes executing the function corresponding to the information item over which any of the two touched points is placed.

18. A navigation method, comprising:
displaying, on a display unit having a touch panel, a map and an icon;
detecting a touch on the touch panel at two touched points;
determining whether the icon is selected by the touch at the two touched points;
displaying information of a plurality of functions associated with the icon respectively in a plurality of information items in the vicinity of the selected icon;
in response to a detection that any of the two touched points is placed over one of the information items and upon subsequent removal of the touch at the two touched points, executing the function corresponding to said information item with respect to a current position of the icon on the map.

19. The navigation method according to claim 18, further comprising
in response to the detection that any of the two touched points is placed over one of the information items, displaying over the icon the information of the function corresponding to said information item.

20. A computer-readable medium containing a program for causing, when executed by a navigation device, the navigation device to execute the method of claim 13.
